(19) United States
(12) Patent Application Publication
(10) Pub. No.: US 2009/0151257 A1
(43) Pub. Date: Jun. 18, 2009

(54) POWER CLOSING LATCH DEVICE

(76) Inventor: Christer Gustav Dominique, Torslanda (SE)

Correspondence Address: PRICE, HENEVELD, COOPER, DEWITT & LITTON, LLP;FGTL, 695 KENMOOR S.E., P. O. BOX 2567, GRAND RAPIDS, MI, 49501-2567, US

(21) Appl. No.: 12/333,474

(22) Filed: Dec. 12, 2008

(30) Foreign Application Priority Data
Dec. 14, 2007 (EP) 07123287.0

(51) Int. Cl. E05B 65/12

(52) U.S. Cl. 49/280; 292/2

(57) ABSTRACT

A power closing latch device for a door or lid in a vehicle, which device comprises a claw, a pawl and a striker. The pawl meshes with a safety recess and a lock recess of the claw in a safety position and a locked position. The striker is provided in a groove and rotates together with the claw, at closing of the door or lid. A spring is provided acting on the claw, which spring keeps the claw in the safety position, when the door or lid is partially closed. An electric motor rotates the claw between the safety position and the closed position. An additional spring acting on the claw, which additional spring exert a counterforce on the claw to prevent the claw to stop in an undefined position, between the safety position and the closed position during a power closing process. A method for power closing of a door or lid of a vehicle is also provided.

### FIELD OF THE INVENTION

The present invention relates generally to a power closing latch device for a door or lid in a vehicle and a method for power closing of a door or lid in a vehicle.

### BACKGROUND OF THE INVENTION

In newly produced vehicles it is an aim to attain an interior passenger compartment, which is as quiet as possible. One measure that is taken to achieve this is to attain high sealing forces between doors or lids and the body of the vehicle is to reduce and mitigate disturbing noise from the outside environment to penetrate into the passenger compartment of the vehicle. To be able to close the door or lid, the sealing forces must be overcome, and this is possible with an automatic closing device.

In the door or lid and the vehicle body a power closing latch device according to prior art is provided. The power closing latch device comprises a claw, a pawl and a striker cooperating with the claw. The claw has a safety recess and a lock recess and is rotatable between an open position, a safety position and a locked position. The pawl is rotatable and meshes with the safety recess and the lock recess in the safety position and the locked position. The striker is provided in a groove in the claw in the safety and locked position and the striker is pushed in a straight motion into the claw, at closing of the door or lid, from the open position to the safety position and to the locked position. A spring acts on the claw and the spring keeps the claw in the safety position, when the door or lid is partially closed. A power closing unit comprising an electric motor rotates the claw between the safety position and the closed position. The striker is fixed on the vehicle and is struck by the claw during the closing process.

One way to attain high sealing forces and a quiet interior passenger compartment is to use sealing strips, applied between the doors or lids and the vehicle body, which sealing strips are rigid and exert a force which pushes the doors or lids outwards. The sealing strips cooperate with the power closing latch device.

One drawback with the high sealing forces exerted by, for example, sealing strips is that it is hard to overcome the sealing forces to close the door or lid to a fully closed position by hand as the pawl just reaches the safety position. Accordingly the electric motor is used to facilitate the closing of the door or lid from the safety position to the closed position.

At closing of the door or lid by hand, the spring acting on the claw exerts a counter force which is overcome by the force the occupant uses to close the door. At closing of the door or lid the striker meshes with a groove in the claw. The pawl meshes with the safety recess in the claw, whereafter the electric motor rotates the claw and the pawl meshes with the lock recess to close the door. At the position when the pawl meshes with the safety recess, a sensor device is triggered to activate the electric motor and the motor rotates the claw so that the pawl can mesh with the lock recess of the claw.

As long as the sealing strips have rigid properties and push the door or lid outwards, high sealing forces between the door or lid and the vehicle body can be obtained, and the pawl can easily reach the safety recess and the lock recess.

When the sealing strips gradually lose their rigid properties due to age or being in a cold environment, the sealing strips exert lower forces that push the door or lid outwards. When this occurs, the spring force acting on the claw becomes too high and this leads to larger tolerances and the claw moves past the safety recess too fast to trigger the sensor device. As a result, the electric motor will not receive a signal to rotate the claw so that the pawl can mesh with the lock recess, and thus the pawl never reaches the lock recess. The claw may stop in an undefined position, between the safety and open positions, which undefined position cannot be detected by the sensor device. The effect of this is that the sensor device that senses that the claw and the pawl meshes in the safety recess cannot be triggered. The result is that the electric motor releases the claw, since the missing signal is an indication that the door or lid is open.

Prior art power closing latch devices are configured to use an additional switch which senses when the pawl is in the undefined position, but to implement an extra switch will result in several drawbacks. An additional switch will occupy more space within the device, which will make the device larger which is not desirable due to already high demands on less bulky parts. An additional switch will also lead to more expensive electronics and cables must be installed. Thus, the more electronics that are used the harder it is to attain a long operating time during the whole lifetime of the vehicle.

It is therefore desirable to provide an improved power closing latch device which will close the doors or lids to a fully closed position, independent of the sealing forces exerted by sealing strips.

It is further desirable to provide a power closing latch device that will require minor adjustments at assembly in the factory and that will not take up a great deal of space and that is inexpensive to manufacture.

### SUMMARY OF THE INVENTION

The above problems have been solved by a method and a power closing latch device according to the appended claims.

According to one aspect of the present invention, automatic closing of doors and lids by a power closing latch device in a vehicle is provided. The power closing latch comprises a claw, which is rotatable around a first pivot between an open position, a safety position and a locked position. The claw has a safety recess and a lock recess. The power closing latch device comprises a pawl, which is rotatable around a second pivot. The pawl meshes with the safety recess and the lock recess in the safety position and the locked position. A striker is positioned in a groove in the claw in the safety and locked positions and the striker is arranged to be pushed in a straight motion into the claw, at closing of the door or lid, from the open position to the safety position and to the locked position. A first spring is acting on the claw, which spring is arranged to maintain the claw in the safety position, when the door or lid is partially closed. A power closing unit is arranged to rotate the claw between the safety position and the closed position during a power closing process. A second spring is acting on the claw and the second spring is arranged to exert a counterforce on the claw and to prevent the claw from stopping in an undefined position, between the safety position and the closed position during the power closing process.

According to further aspects of the present invention, the first spring and the second spring acting on the claw can be achieved in a number of ways by means of a suitable spring device acting on the claw. Examples of such spring devices are a push spring cylinder, a torsion spring, a coil spring, a resilient tongue or similar. The power closing unit is arranged to overcome the counterforce of the second spring in the safety position, and is arranged to rotate the claw to the closed position. The second spring is arranged to hold the claw in the safety position, until a first detection unit and a second detection unit activates the power closing unit which is arranged to rotate the claw to the closed position. A first detection unit and a second detection unit are arranged to detect when the claw and the pawl is in the open position, safety position or closed position. The second detection unit is arranged to detect the motion of the pawl, when it meshes with the safety recess and the lock recess. The first detection unit is arranged to detect the motion of the claw, when it rotates between the open position, safety position and the locked position. The first and second detection units may be suitable electrical switches, such as microswitches. A disengaging device is provided to release the claw, the pawl and the striker from the locked position and the safety position to the open position.

According to a further aspect of the present invention, a method for power closing of a door or lid in a vehicle is provided, comprising the steps of: rotating a claw around a first pivot between an open position, a safety position and a locked position, rotating a pawl around a second pivot, when the pawl meshes with the safety recess and the lock recess in the safety position and the locked position, pushing a striker in a straight motion, provided in a groove in the claw in the safety position and the locked position, together with the claw, at closing of the door or lid, from the open position to the safety position and to the locked position, actuating a first spring on the claw, which spring keeps the claw in the safety position, when the door or lid is partially closed, and driving an power closing unit which rotates the claw between the safety position and the closed position during a power closing process, and actuating an additional second spring acting on the claw, which additional spring exerts a counterforce on the claw to prevent the claw from stopping in an undefined position, between the safety position and the closed position during the power closing process.

According to yet a further aspect of the invention, the method further comprises the step of overcoming the counterforce exerted of the additional spring in the safety position by the power closing unit, which rotates the claw to the closed position.

These and other features, advantages and objects of the present invention will be further understood and appreciated by those skilled in the art by reference to the following specification, claims and appended drawings.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 shows a schematic isometric view of a vehicle provided with at least one power closing latch device, according to one embodiment;

FIG. 2 shows a front view of a power closing latch device in an open position, mounted in a luggage boot;

FIG. 3A shows a schematic view of a power closing latch device in an open position;

FIG. 3B shows a sequence diagram with the open position marked with “Open;”

FIG. 4A shows a schematic view of a power closing latch device in a safety position;

FIG. 4B shows a sequence diagram with the safety position marked with “Safety;”

FIG. 5A shows a schematic view of a power closing latch device in an undefined position;

FIG. 5B shows a sequence diagram with the undefined position marked with “Undefined”;

FIG. 6A shows a schematic view of a power closing latch device in a closed position;

FIG. 6B shows a sequence diagram with the closed position marked with “Closed;” and

FIG. 7 shows a schematic diagram of spring forces acting of the claw.

### DETAILED DESCRIPTION OF THE PREFERRED EMBODIMENTS

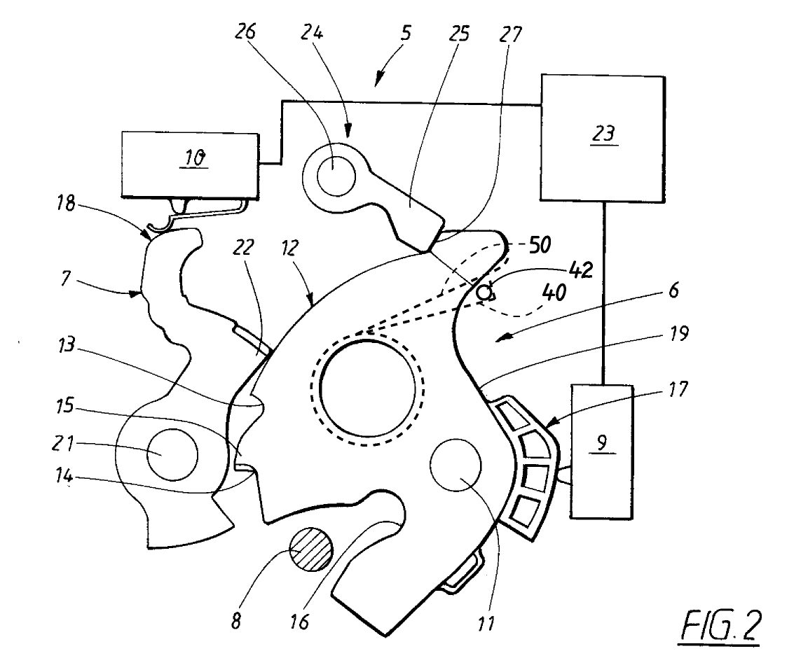

In the description below various directions are given such as front, rear, side, up and down. These directions are given with reference to a vehicle driving in a forward direction and to the orientation of the particular embodiment shown in the figures. The power closing device according to the invention can be oriented in different ways, and one possible orientation is shown in FIG. 2. The striker can be fixed on the vehicle or on a pivoting part of the vehicle and vice versa to the rest of the power closing device according to the invention.

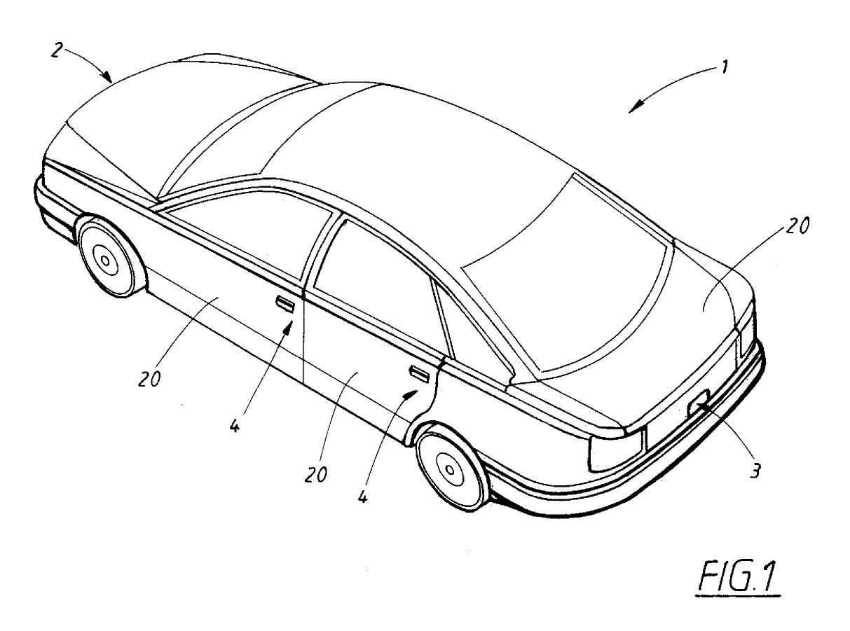

FIG. 1 shows a schematic isometric view of a vehicle 1 with a front 2, a rear 3 and sides 4. The doors, the bonnet, the boot lid, luggage boot or other lids can be provided with an automatic closing device in the form of the power closing latch device 5 according to one embodiment of the invention.

FIG. 2 shows a view of a power closing latch device 5 in an open position. The view shows a claw 6, a pawl 7, a striker 8 and first and second detection units 9, 10.

The claw 6 is provided with a first pivot 11, around which the claw 6 is rotatable between an open position, an undefined position and a safety position and a locked position. Around the periphery 12 of the claw 6, the claw 6 is provided with a safety recess 13 and a lock recess 14 which are provided in the vicinity of each other. Between the safety recess 13 and the lock recess 14 there is provided a protrusion 15 acting as a separator.

Around the periphery 12 of the claw 6 a groove 16 and a first detection surface 17 are provided. The groove 16 is provided next to the lock recess 14 and the first detection surface 17 is provided next to the groove 16 and on an opposed edge 19 in relation to the safety recess 13 and the lock recess 14. The groove 16 is principally U-shaped and the striker 8 is provided in the groove 16 in the safety position, undefined position and the lock position. In the open position the groove 16 is principally directed downwards, in the embodiment shown in FIG. 2. The power closing latch device 5 according to various embodiments of the invention can of course be oriented in various different directions.

The first detection surface 17 is unsymmetrical and, upon rotation of the claw 6 between the safety position and the lock position, the first detection surface 17 will lose contact with the first detection unit 9.

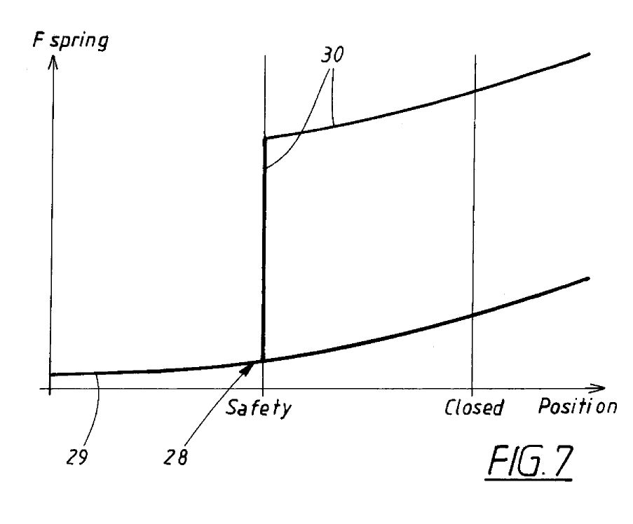

A first spring 50 is acting on the claw 6, which spring 50 is arranged to maintain the claw 6 in the completely opened position, when the door 20 or lid is partially closed or open. When fitted, the spring 50 also exerts a minor counterforce (see in FIG. 7, first low part of the curve) on the door 20 or lid when it is going from the open position to the partially closed state in the safety position. The spring 50 operates all the way from open to completely closed positions but the force applied from safety position and on is weaker compared with the force applied from an additional spring 40 that starts acting from safety and onwards.

The striker 8 is constituted of a loop produced by a solid bar. The striker 8 is preferably fixed attached to the body of the vehicle and the remaining parts of the power closing latch device 5 are mounted in the door, lid, etc. The striker 8 is arranged to be pushed into the groove 16 of the claw 6 in a straight motion, at closing of the door or lid, from the open position to the safety position and further to the locked position.

The pawl 7 is provided with a second pivot 21, the second detection surface 18 and an engaging protrusion 22. The pawl 7 is rotatable arranged around the second pivot 21, so that the engaging protrusion 22 can engage with the safety recess 13 and the lock recess 14 in the safety position and the lock position. The pawl 7 is preloaded in the position shown in FIG. 2 and rotates in a clockwise direction towards the claw 6 when the pawl 7 is allowed to rotate feely.

Further, the power closing latch device comprises the first detection unit 9 and the second detection unit 10. The first detection unit 9 detects in which position the claw 6 is in, by contact with or no contact with the first detection surface 17. The second detection unit 10 detects in which position the pawl 7 is in, by contact with or no contact with the first detection surface 17. This will be described in detail below.

An additional or second spring 40 is acting on the claw 6. The additional spring 40 abuts a stop pin 42 to keep the spring 40 pretensioned. The additional spring 40 is arranged to exert a counterforce on the claw 6 and to prevent the claw 6 from stopping in the undefined position, between the safety position and the closed position during a power closing process. Thus, the additional spring holds the claw 6 in the safety position until a power closing unit (not shown) is activated. Thus, the force exerted by the additional spring 40 will prevent an occupant of the vehicle to close the door or lid to an extent that the undefined position or safety position is reached. The power closing unit is arranged to rotate the claw 6 between the safety position and the closed position during a power closing process. The power closing unit is arranged to overcome the counterforce of the additional spring.

The additional spring 40 is arranged to hold the claw 6 in the safety position, until the first detection unit 9 and the second detection unit 10 activates the power closing unit, which rotates the claw to the closed position.

The first detection unit 9 and second detection unit 10 is arranged to detect when the claw 6 and the pawl 7 is in the open position, safety position or closed position. The first detection unit 9 is arranged to detect the motion of the claw 6, when it rotates between the open position, safety position and the locked position. The second detection unit 10 is arranged to detect the motion of the pawl 7, when it meshes with the safety recess 13 and the lock recess 14. The first and second detection units 9, 10 are preferably switches. The first and second detection units 9, 10 are connected to a comparison unit 23 which analyzes the positions of the first and second detections units 9, 10, and, if appropriate, the comparison unit activates an electric motor in the power closing unit and rotates the claw 6 to the closed position.

A disengaging device 24 is provided to release the claw 6, the pawl 7 and the striker 8 from the locked position and the safety position to the open position. The disengaging device 24 is schematically shown in FIG. 2 with a catch lever 25. The catch lever 25 is arranged to rotate around a third pivot 26. The catch lever 25 is arranged to abut against the claw 6 at an abutting surface 27. At releasing, the catch lever 24 is arranged to be lifted and release the claw 6, which leads to the striker 8 being released. Thus, the striker 8 and the claw 6 can return to the open position.

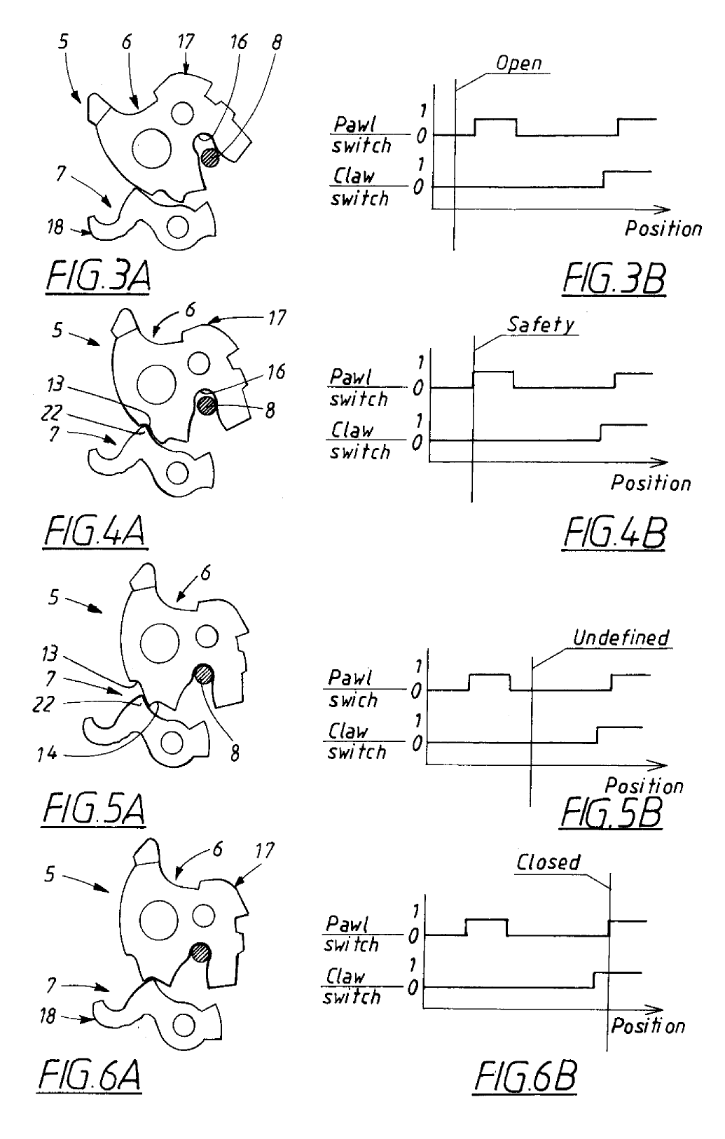

Below, the closing process of a door 20 or lid is going to be described with reference to FIG. 3A to 6A, and the corresponding initiation signals from the first and second detection units 9, 10 are shown in FIGS. 3B to 6B. If the detection units 9, 10 are in contact with the claw 6 or the pawl 7, no signals are emitted, which is shown by “0.” On the contrary, if the detection units 9, 10 are not in contact with the claw 6 or the pawl 7, signals are emitted, which is shown by “1.”

FIG. 3A shows a schematic view of the power closing latch device 5 in the open position. In this open position the first detection unit 9 is in contact with the first detection surface 17 of the claw 6, which is shown by “0,” and the second detection unit 10 is in contact with the second detection surface 18 of the pawl 7, which is shown by “0,” shown at position “Open” in FIG. 3B. Here the striker 8 is not in contact with the groove 16.

FIG. 4A shows a schematic view of the power closing latch device 5 in the safety position. The door 20 or lid has started to close and the striker 8 is moved in a straight motion into the groove 16 and the striker 8 has come to engagement with the groove 16. Due to the motion of the striker 8 towards the claw 6, the claw 6 has started to rotate in a clockwise direction, which leads to that the pawl 7 loses its contact with the second detection unit 10, which is shown by “1,” when the engaging protrusion 22 of the pawl 7 meshes with the safety recess 13 of the claw 6. The first detection surface 17 of the claw 6 is thus still in contact with the first detection unit 9, which is shown by “0,” shown at position “Safety” in FIG. 4B. If the pawl 7 is maintained in a position without contact with the second detection unit 10 during a preset time interval, the power closing unit is activated, to rotate the claw 6 to the closed position.

If the pawl 7 is maintained in a position without contact with the second detection unit 10 during a shorter time interval than the preset time interval, the comparison unit 23 will detect “0” from the first detection unit 9 and also from the second detection unit 10, and the comparison unit 23 will believe that the door 20 or lid is still in the open position and the power closing device will release the claw 6 and striker 8 to return to the open position. The additional spring is acting on the claw 6 and exerts a counterforce on the claw 6, which keeps the engaging protrusion 22 of the pawl 7 in the safety recess 13 and prevents the claw 6 to accidentally rotate to the undefined position, as shown in FIG. 5A.

FIG. 5A shows a schematic view of the power closing latch device 5 in the undefined position. By means of the power closing latch device according to the invention the pawl 7 will not stop in the undefined position, so this position is shown for the sake of clarity. Due to the motion of the striker 8 towards the claw 6, the claw 6 rotates in a clockwise direction, which lead to that the pawl 7 gains its contact with the second detection unit 10, which is shown by “0,” when the engaging protrusion 22 of the pawl 7 slides between the safety recess 13 and the lock recess 14. The first detection unit 9 will thus still be in contact with the first detection unit 9, which is shown by “0,” shown at position “Undefined” in FIG. 5B. When the pawl 7 and the claw 6 are in this undefined position the comparison unit 23 will detect the same signals as in the open position, and will thus release the power closing unit, which will open the power closing latch device 5.

The additional spring 40 will thus prevent that the claw 6 will stop in the undefined position, since the additional spring will strive to hold the engaging protrusion in the safety recess 13 until the power unit device will rotate the power closing latch device 5 to a closed position.

FIG. 6A shows a schematic view of the power closing latch device 5 in the closed position. In the closed position the additional spring and the power closing latch unit have rotated the pawl 7 and the claw 6 to that extent that the first detection surface 17 has lost its contact with the first detection unit 9, which is shown by “1” in FIG. 6A. The second detection unit 10 has also lost its contact with the second detection surface 18, which is shown by “1” in FIG. 6A. The first detection unit 9 will lose contact just before the second detection unit 10. When both the first detection unit 9 and the second detection unit 10 is denoted by “1” the power closing unit will be turned off since the door 20 or lid is in the closed position.

FIG. 7 shows a schematic diagram of spring forces. Curve 28 shows the spring force according to known art. Curve 29 shows the spring force from the spring acting on the claw 6 until the safety position is reached. Curve 30 shows the spring force from the additional spring acting of the claw 6 from the safety position to the closed position. From the safety position the additional spring comes to engagement with the claw 6 and prevents the claw 6 from stopping in the undefined position. This is shown at position “Closed.”

Accordingly, provided is a power closing latch comprising: a claw, which is rotatable around a first pivot between an open position, a safety position and a locked position, and the claw has a safety recess and a lock recess, a pawl, which is rotatable around a second pivot, which pawl meshes with the safety recess and the lock recess in the safety position and the locked position, a striker, which is positioned in a groove in the claw in the safety and locked positions and which striker is arranged to be pushed in a straight motion into the claw, at closing of the door or lid, from the open position to the safety position and to the locked position, a spring acting on the claw, which spring is arranged to maintain the claw in the safety position, when the door or lid is partially closed, and a power closing unit arranged to rotate the claw between the safety position and the closed position during a power closing process.

Also provided is a method for power closing of a door or lid in a vehicle, comprises the steps of: rotating a claw around a first pivot between an open position, a safety position and a locked position, rotating a pawl around a second pivot, when the pawl meshes with the safety recess and the lock recess in the safety position and the locked position, pushing a striker in a straight motion, provided in a groove in the claw in the safety position and the locked position, together with the claw, at closing of the door or lid, from the open position to the safety position and to the locked position, actuating a spring on the claw, which spring keeps the claw in the safety position, when the door or lid is partially closed, and driving a power closing unit which rotates the claw between the safety position and the closed position during a power closing process.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A power closing latch device for a door or lid in a vehicle, said power closing latch comprising:
a claw rotatable around a first pivot between an open position, a safety position and a locked position, the claw having a safety recess and a lock recess;
a pawl rotatable around a second pivot, wherein said pawl meshes with the safety recess and the lock recess in the safety position and the locked position;
a striker positioned in a groove in the claw in the safety and locked positions, said striker arranged to be pushed in a straight motion into the claw, at closing of the door or lid, from the open position to the safety position and to the locked position;
a first spring acting on the claw, wherein said spring is arranged to maintain the claw in the safety position, when the door or lid is partially closed;
a power closing unit arranged to rotate the claw between the safety position and the closed position during a power closing process; and
a second spring acting on the claw, wherein said second spring is arranged to exert a counterforce on the claw and to prevent the claw from stopping in an undefined position, between the safety position and the closed position during the power closing process.

2. The power closing latch device according to claim 1, wherein the power closing unit is arranged to overcome the counterforce of the second spring in the safety position, and is arranged to rotate the claw to the closed position.

3. The power closing latch device according to claim 1, wherein the second spring is arranged to hold the claw in the safety position, until a first detection unit and a second detection unit activates the power closing unit which is arranged to rotate the claw to the closed position.

4. The power closing latch device according to claim 3, wherein the first detection unit and the second detection unit are arranged to detect when the claw and the pawl is in the open position, safety position or closed position.

5. The power closing latch device according to claim 4, wherein the second detection unit is arranged to detect the motion of the pawl, when it meshes with the safety recess and the lock recess.

6. The power closing latch device according to claim 4, wherein the first detection unit is arranged to detect the motion of the claw, when it rotates between the open position, safety position and the locked position.

7. The power closing latch device according to claim 3, wherein the first and second detection units are switches.

8. The power closing latch device according to claim 1 further comprising a disengaging device to release the claw, the pawl and the striker from the locked position and the safety position to the open position.

9. A method for power closing of a door or lid in a vehicle, comprising the steps of:
rotating a claw around a first pivot between an open position, a safety position and a locked position;
rotating a pawl around a second pivot, when the pawl meshes with the safety recess and the lock recess in the safety position and the locked position;
pushing a striker in a straight motion, provided in a groove in the claw in the safety position and the locked position, together with the claw, at closing of the door or lid, from the open position to the safety position and to the locked position;
actuating a first spring on the claw, which spring keeps the claw in the safety position, when the door or lid is partially closed;
driving a power closing unit which rotates the claw between the safety position and the closed position during a power closing process; and
actuating a second spring acting on the claw, wherein the second spring exerts a counterforce on the claw to prevent the claw from stopping in an undefined position, between the safety position and the closed position during the power closing process.

10. The method for power closing of a door or a lid in a vehicle according to claim 9 further comprising the step of overcoming the counterforce exerted by the second spring in the safety position by the power closing unit, which rotates the claw to the closed position.

11. A vehicle having a door or lid, said vehicle comprising a power closing latch comprising:
a claw rotatable around a first pivot between an open position, a safety position and a locked position, the claw having a safety recess and a lock recess;
a pawl rotatable around a second pivot, wherein said pawl meshes with the safety recess and the lock recess in the safety position and the locked position;
a striker positioned in a groove in the claw in the safety and locked positions, said striker arranged to be pushed in a straight motion into the claw, at closing of the door or lid, from the open position to the safety position and to the locked position;
a first spring acting on the claw, wherein said spring is arranged to maintain the claw in the safety position, when the door or lid is partially closed;
a power closing unit arranged to rotate the claw between the safety position and the closed position during a power closing process; and
a second spring acting on the claw, wherein said second spring is arranged to exert a counterforce on the claw and to prevent the claw from stopping in an undefined position, between the safety position and the closed position during the power closing process.
